(19) United States
(12) Patent Application Publication
(10) Pub. No.: US 2010/0134371 A1
(43) Pub. Date: Jun. 3, 2010

(54) INCREASED BANDWIDTH PLANAR ANTENNAS

(76) Inventor: Robert Tilman Worl, Maple Valley, WA (US)

Correspondence Address: KLINTWORTH & ROZENBLAT IP LLC;AND THE BOEING COMPANY, 300 West Adams Street, Suite 505, CHICAGO, IL, 60606, US

(21) Appl. No.: 12/327,461

(22) Filed: Dec. 3, 2008

(51) Int. Cl. H01Q 1/38; H01P 11/00; H01Q 1/36; H01Q 11/10

(52) U.S. Cl. 343/792.5; 343/700 MS; 29/600; 343/895

(57) ABSTRACT

A broadband antenna may include a conductive antenna surface for radiating signals, a conductive backplane for reflecting signals radiated by the conductive antenna surface, and a dielectric layer disposed between the conductive antenna surface and the conductive backplane. The dielectric layer may include a plurality of dielectric substrates having differing dielectric constants.

### FIELD OF THE DISCLOSURE

The field of the disclosure relates to broadband planar antennas.

### BACKGROUND

It is often advantageous for antennas to be able to perform various functions over a broad frequency spectrum. Some of the current antennas use a federated approach to cover a large bandwidth at lower frequencies. Issues that may arise when trying to cover these lower frequencies are size, weight, mounting, and aero concerns, especially for large planar cavity-backed or protruding antennas (e.g. blades, dishes . . . ). Some developing ASW/ISR platforms simply cannot bear the additional drag counts that a typical and widely used blade antenna may incur or suffer the structural changes that a cavity-backed antenna would require. It has long been known that for narrow band antennas, when the antenna is placed near a conducting backplane the spacing between the antenna and the backplane must be designed at a specific electrical distance based on the antenna's operating frequency. This technique is used today in many different types of designs yet it almost always implies a narrow band structure. It has been shown in theory and practice that certain classes of frequency independent antennas can be placed above complex geometry conducting backplanes to maintain the antenna's broad-band response. However, these types of antennas are generally large, and difficult to build because the largest distance that they have to be from the backplane is on the order of a quarter wavelength at the lowest operating frequency.

A broadband antenna and/or method of manufacturing is needed to decrease one or more problems associated with one or more of the existing broadband antennas.

### SUMMARY

In one embodiment, a broadband antenna is provided. The broadband antenna may include: a conductive antenna surface for radiating signals; a conductive backplane for reflecting signals radiated by the conductive antenna surface; and a dielectric layer disposed between the conductive antenna surface and the conductive backplane. The dielectric layer may comprise a plurality of dielectric substrates having differing dielectric constants.

In another embodiment, a method of manufacturing a broadband antenna is disclosed. In one step, a conductive antenna surface may be provided. In another step, a conductive backplane may be provided. In an additional step, a dielectric layer, comprising a plurality of dielectric substrates having differing dielectric constants, may be disposed between the conductive antenna surface and the conductive backplane.

In yet another embodiment, a method of manufacturing a broadband antenna is disclosed. In one step, a lowest required operating frequency of the broadband antenna is determined. In another step, a highest required operating frequency of the broadband antenna is determined. In an additional step, a uniform thickness for an entire dielectric layer at a specified electrical distance is calculated at the lowest required operating frequency based on a dielectric material to be used in the dielectric layer having a highest dielectric constant. In still another step, the lowest required dielectric constant of the dielectric layer is calculated based on the calculated uniform thickness of the dielectric layer at the specified electrical distance to generate the specified electrical distance at the highest required operating frequency. In yet another step, the number of different dielectric materials to be used in the dielectric layer having differing dielectric constants between the lowest required dielectric constant and the highest dielectric constant is calculated based on a total bandwidth of the broadband antenna. In an additional step, widths of each of the respective differing dielectric materials to be used in the dielectric layer are calculated. In another step, the dielectric layer is fabricated using the calculations and determinations made in all steps of the method. In still another step, the dielectric layer is disposed against a conducting backplane. In another step, an antenna is disposed against the dielectric layer.

These and other features, aspects and advantages of the disclosure will become better understood with reference to the following drawings, description and claims.

### BRIEF DESCRIPTION OF THE DRAWINGS

FIG. 1 shows an exemplary side-view of one embodiment of a conventional varying-electrical distance apparatus having varying physical distances;

FIG. 2 shows a side-view of one embodiment of a varying-electrical distance apparatus designed to have varying-electrical distances which are substantially identical to the varying-electrical distances of the conventional apparatus of FIG. 1;

FIG. 3 shows a top view of one embodiment of a conventional Archimedean spiral antenna to which one or more embodiments may be applied;

FIG. 4 shows a top view of one embodiment of a conventional log periodic bowtie antenna to which one or more embodiments may be applied;

FIG. 5 shows a side-view of the conventional Archimedean spiral antenna of FIG. 3;

FIG. 6 shows a side-view of one embodiment of a broadband Archimedean spiral antenna designed to have varying-electrical distances substantially identical to the varying-electrical distances of the conventional Archimedean spiral antenna of FIG. 5;

FIG. 7 is a flowchart of one embodiment of a method of manufacturing a broadband antenna; and

FIG. 8 is a flowchart of another embodiment of a method of manufacturing a broadband antenna.

### DETAILED DESCRIPTION

The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims.

FIG. 1 shows an exemplary side-view of one embodiment of a conventional varying-electrical distance apparatus 10. The apparatus 10 may comprise conductive surfaces 12 and 14 separated apart from one another. A vacuum or gas 16 such as air may be disposed between the conductive surfaces 12 and 14. The conductive surfaces 12 and 14 may be disposed apart from one another by a varying electrical distance 18 due to conductive surface 14 extending at an angle 20 away from conductive surface 12. For instance, one end 14a of conductive surface 14 may be disposed at a smaller electrical distance 18a away from conductive surface 12 than the electrical distance 18b the other end 14b of conductive surface 14 is disposed away from conductive surface 12. For purposes of this application, the term “electrical distance” is defined as the duration of travel of an electromagnetic wave between two points. The electrical distance 18 between conductive surface 12 and 14 may gradually increase in direction 21 from the smallest electrical distance 18a at end 14a of conductive surface 14 to the largest electrical distance 18b at end 14b of conductive surface 14.

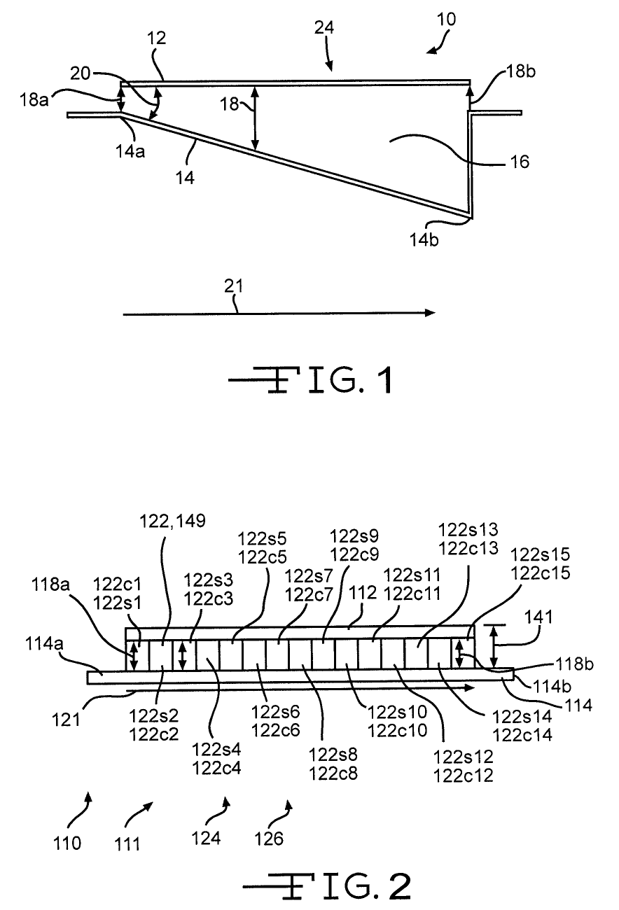

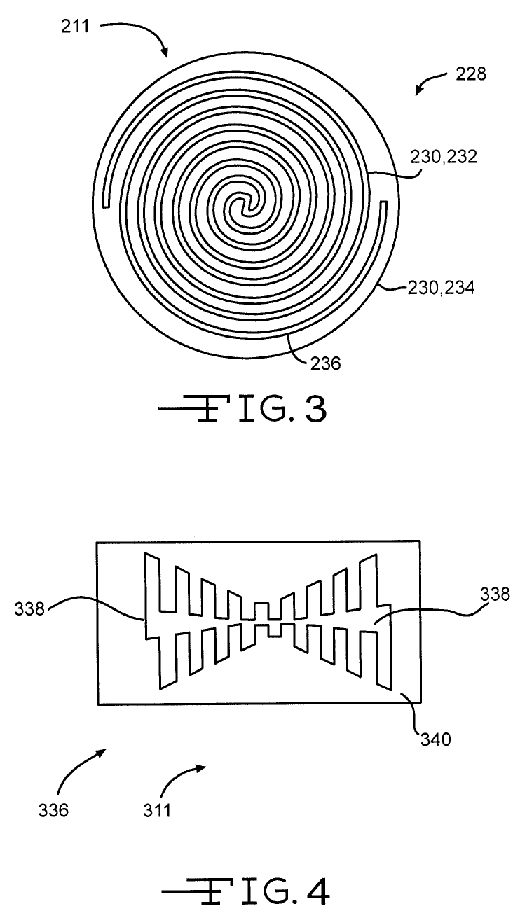

FIG. 2 shows a side-view of one embodiment under the disclosure of a varying-electrical distance apparatus 110 which was designed to have varying-electrical distances 118 which are substantially identical to the varying-electrical distances 18 of the conventional apparatus 10 of FIG. 1. In one embodiment, the varying-electrical distance apparatus 110 may comprise an antenna, such as a broadband antenna, which is used on a structure 111 comprising a ship, an airplane, a satellite, a spacecraft, a vehicle, and/or another type of structure. The apparatus 110 may be flat and planar. In other embodiments, the apparatus 110 may be non-planar and/or of different shapes. The apparatus 110 may comprise conductive surfaces 112 and 114 separated apart by a small distance 141 from one another in parallel relation. The conductive surfaces 112 and 114 may be flat and planar. The conductive surfaces 112 and 114 may comprise a part of a ship, an airplane, a satellite, a spacecraft, a vehicle, and/or another type of structure. In other embodiments, the conductive surfaces 112 and 114 may be non-planar and/or in varying shapes.

A dielectric layer 122 may be disposed between and/or against the conductive surfaces 112 and 114 using a direct write process 149 and/or other type or process. The dielectric layer 122 may be flat and planar. In other embodiments, the dielectric layer 122 may be non-planar and/or in varying shapes. The dielectric layer 122 may comprise a plurality of dielectric substrates 122s1-122s15 having differing dielectric constants 122c1-122c15. The respective dielectric substrates 122s1-122s15 may have gradually larger (increasing) respective dielectric constants 122c1-122c15 along direction 121 from the dielectric substrate 122s1 with the lowest dielectric constant 122c1 to the dielectric substrate 122s15 with the highest dielectric constant 122c15. The electrical distance 118 between the conductive surfaces 112 and 114 may vary substantially identically along direction 121 as, in the conventional apparatus of FIG. 1, the electrical distance 18 varies along direction 21 between the conductive surfaces 12 and 14. This may be the result of the use of the plurality of dielectric substrates 122s1-122s15 having differing dielectric constants 122c1-122c15 which gradually increase along direction 121 in order to provide a smooth, gradually increasing electrical distance 118 transition from the lowest electrical distance 118a to the highest electrical distance 118b.

The end 114a of conductive surface 114 may be disposed at a substantially identical electrical distance 118a away from conductive surface 112 as, in the conventional apparatus 10 of FIG. 1, the electrical distance 18a between the end 14a of the conductive surface 14 and the conductive surface 12. The end 114b of conductive surface 114 may be disposed at a substantially identical electrical distance 118b away from conductive surface 112 as, in the conventional apparatus 10 of FIG. 1, the electrical distance 18b between the end 14b of the conductive surface 14 and the conductive surface 12. The electrical distance 118 may be substantially identical at every location along direction 121 in between electrical distances 118a and 118b as, in the conventional apparatus 10 of FIG. 1, the electrical distance 18 at every location along direction 21 in between electrical distances 18a and 18b. The respective wavelengths 24 and 124 of the conventional apparatus 10 of FIG. 1 and the apparatus 110 of FIG. 2 may be substantially electrically equivalent. The embodiment of FIG. 2 may display superior performance by using different respective dielectric substrates 122s1-122s15 having gradually increasing dielectric constants 122c1-122c15 along direction 121 for every Gigahertz of bandwidth 126.

FIG. 3 shows atop view of one embodiment of a conventional Archimedean spiral antenna 228 to which one or more embodiments of the disclosure may be applied. The Archimedean spiral antenna 228 may comprise a conductive antenna surface 230 comprising two discrete spiraling conductive surfaces 232 and 234. A groundplane 236 may be disposed below the conductive antenna surface 230. The spiral antenna 228 may have points in space where a given frequency in its total bandwidth radiates. The spiral antenna 228 may comprise a broadband antenna used on a structure 211 comprising a ship, an airplane, a satellite, a spacecraft, a vehicle, and/or another type of structure. In other embodiments, the disclosure may be used for varying types of antennas, spiral antennas, and/or other types of non-spiral antennas.

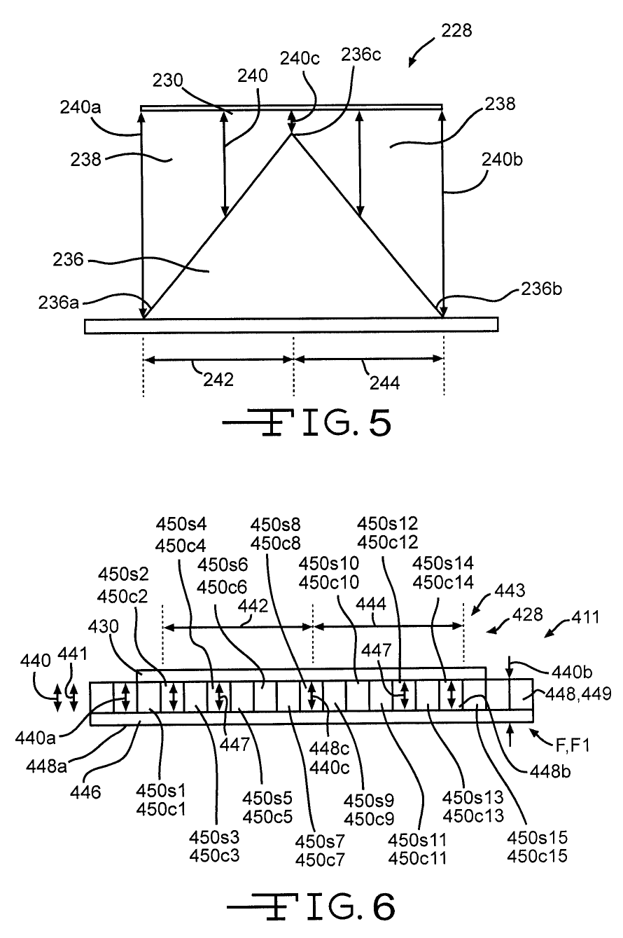

FIG. 4 shows a top view of one embodiment of a conventional log periodic bowtie antenna 336 to which one or more embodiments of the disclosure may be applied. The log periodic bowtie antenna 336 may comprise a conductive antenna surface 338 in the shape of a bow-tie. A groundplane 340 may be disposed below the conductive antenna surface 338. The log periodic bowtie antenna 336 may comprise a broadband antenna used on a structure 311 comprising a ship, an airplane, a satellite, a spacecraft, a vehicle, and/or another type of structure. In other embodiments, the disclosure may be used for varying types of antennas.

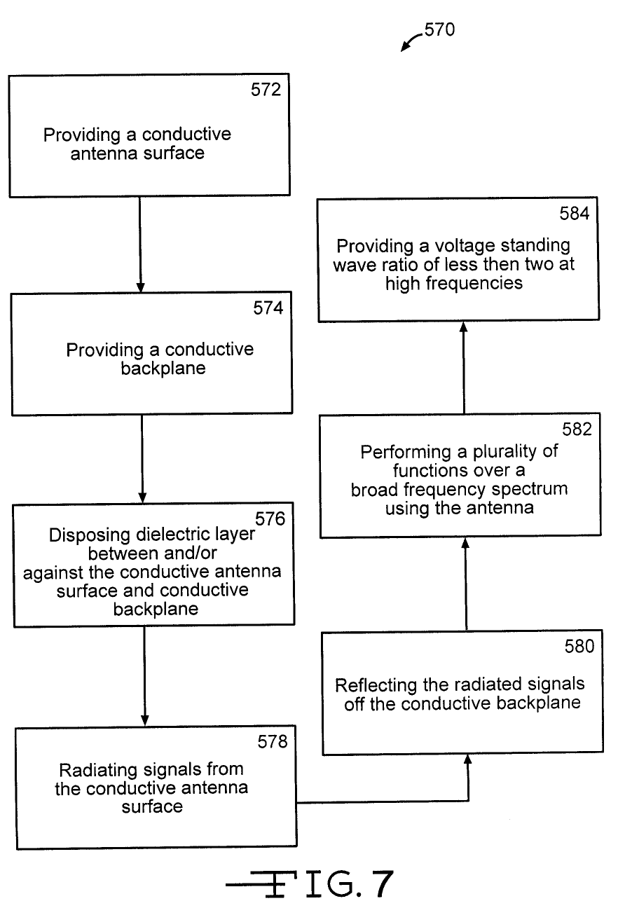

FIG. 5 shows a side-view of the conventional Archimedean spiral antenna 228 of FIG. 3. The conductive antenna surface 230 may be disposed apart from the groundplane 236, which may be substantially conical. A vacuum or gas 238 such as air may be disposed between the groundplane 236 and the conductive antenna surface 230. The electrical distance 240 between the conductive antenna surface 230 and the ground plane 236 may vary due to the conical groundplane 236. At outer portions 236a and 236b of the ground plane 236, the respective electrical distances 240a and 240b between the conductive antenna surface 230 and the ground plane 236 may be the largest. At a middle portion 236c of the ground plane 236, the electrical distance 240c between the conductive antenna surface 230 and the ground plane 236 may be the smallest. Along direction 242 between the outer portion 236a and the middle portion 236c, the electrical distance 240 between the conductive antenna surface 230 and the ground plane 236 may gradually decrease. Similarly, along direction 244 between the outer portion 236b and the middle portion 236c, the electrical distance 240 between the conductive antenna surface 230 and the ground plane 236 may gradually decrease.

FIG. 6 shows a side-view of one embodiment under the disclosure of a broadband Archimedean spiral antenna 428 which was designed to have varying-electrical distances 440 which are substantially identical to the varying-electrical distances 240 of the conventional Archimedean spiral antenna of FIG. 5. The antenna 428 may be flat and planar. The antenna 428 may be used on a structure 411 comprising a ship, an airplane, a satellite, a spacecraft, a vehicle, and/or another type of structure. The antenna 428 may have a bandwidth 443 greater than an octave, may perform a plurality of functions F over a broad frequency spectrum F1, and/or may not have any cavity backing. In other embodiments, the antenna 428 may be non-planar, may be in different shapes, may have varying bandwidths 443, may perform varying functions F over varying frequency spectrums F1, and/or may have varying backings.

The broadband Archimedean spiral antenna 428 may comprise a conductive antenna surface 430 disposed apart in parallel relation from a conductive backplane 446. The conductive antenna surface 430 and/or conductive backplane 446 may be flat, may be planar, and/or may be a part of a ship, an airplane, a satellite, a spacecraft, a vehicle, and/or another type of structure. In other embodiments, the conductive antenna surface 430 and/or conductive backplane 446 may be non-planar and/or in varying shapes. The conductive antenna surface 430 may radiate signals 447, such as radio frequency signals and/or other types of signals, and the conductive backplane 446 may reflect the radiated signals 447.

A dielectric layer 448 may be disposed using a direct-write process 449 and/or other type of process against and/or between the conductive antenna surface 430 and the conductive backplane 446. The dielectric layer 448 may be flat and planar. In other embodiments, the dielectric layer may be non-planar and/or in varying shapes. The dielectric layer 448 may comprise a plurality of dielectric substrates 450s1-450s15 having differing dielectric constants 452c1-452c15. The dielectric substrates 450s1-450s15 may comprise concentric rings of varying dielectrics in between the conductive antenna surface 430 and the conductive backplane 446. This may allow a quarter-wavelength back-short to be disposed beneath each frequency of operation in order to emulate a conical ground plane.

The dielectric substrates 450s1 and 450s15 at the outer portions 448a and 448b of the dielectric layer 448 may have the highest dielectric constants 452c1 and 452c15 in order to provide the largest respective electrical distances 440a and 440b between the conductive antenna surface 430 and the conductive backplane 446. At a middle portion 448c of the dielectric layer 448, the dielectric substrate 450s8 may have the lowest dielectric constant 452c8 in order to provide the smallest respective electrical distance 440c between the conductive antenna surface 430 and the conductive backplane 446. Along direction 442 between the outer portion 448a and the middle portion 448c, the electrical distance 440 between the conductive antenna surface 430 and the backplane 446 may gradually decrease. Similarly, along direction 444 between the outer portion 448b and the middle portion 448c, the electrical distance 440 between the conductive antenna surface 430 and the backplane 446 may gradually decrease. Due to the varying dielectric substrates 450s1-450s15, the varying electrical distances 440 between the conductive antenna surface 430 and the conductive backplane 446 may be substantially identical at all respective locations along the dielectric layer 448 as the varying electrical distances 240 between the conductive antenna surface 230 and the ground plane 236 of the conventional Archimedean spiral antenna 228 of FIG. 5.

The Archimedean spiral antenna 428 of FIG. 6 may have a designed frequency response of 3-18 GHz. The spacing 441 between the conductive antenna surface 430 and the conductive backplane 446 may be a small distance such as only one-tenth of an inch which may be a ninety-three percent reduction over the one-and-a-half inch spacing distance 241 between the conductive antenna surface 230 and the outer portions 236a and 236b of the ground plane 236 of the conventional Archimedean spiral antenna 228 of FIG. 5. In other embodiments, the Archimedean spiral antenna 428 of FIG. 6 may have varying frequency responses, and/or may have varying reductions in spacing 441 relative to the spacing 241 of the conventional Archimedean spiral antenna 228 of FIG. 5.

The lower frequency of operation in the Archimedean spiral antenna 428 may be set by the dielectric substrate 450s1 and 450s15 that have the maximum dielectric constant 452c1 and 452c15 and the desired electrical distance 440. Using these two values, the theoretical lower-bound of the antenna's operating band may be calculated. The upper end of the band may be similarly limited by the chosen electrical distance 440 and the dielectric substrate 450s8 having the lowest dielectric constant 452c8.

The Archimedean spiral antenna 428 of FIG. 6 may have a reduced size, reduced return loss, and/or a lower voltage standing wave ratio than antennas having similar functions at similar frequencies that do not have a plurality of dielectric substrates having differing dielectric constants.

In other embodiments, the disclosure may be applied to varying types of antennas having varying geometries with spatially separated radiation points for each frequency of operation throughout their operating bands. This characteristic may allow the use of a quarter-wavelength conductive backplane spacing beneath each frequency's specific point of radiation. The varying types of antennas the disclosure may be applied to may provide for reduced size, reduced return loss, and/or a lower voltage standing wave ratio than varying types of antennas having similar functions at similar frequencies that do not have a plurality of dielectric substrates having differing dielectric constants.

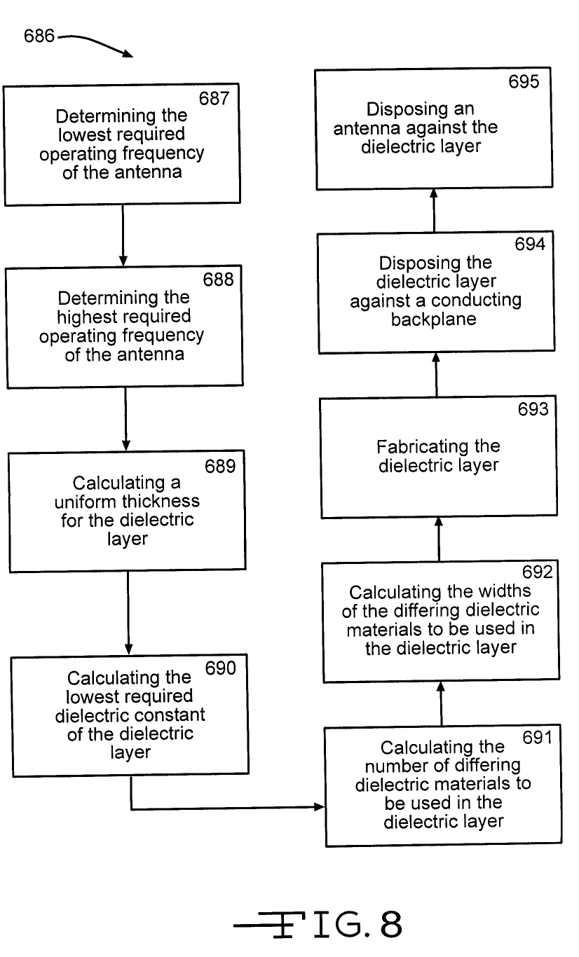

FIG. 7 is a flowchart of one embodiment of a method 570 of manufacturing a broadband antenna 428. The broadband antenna 428 being manufactured may comprise a spiral antenna, an Archimedean spiral antenna, a log periodic bowtie antenna, and/or another type of antenna. The broadband antenna 428 being manufactured may be used on a structure 411 comprising a ship, an airplane, a satellite, a spacecraft, a vehicle, and/or another type of structure.

In step 572, a conductive antenna surface 430 may be provided. In step 574, a conductive backplane 446 may be provided. The provided conductive backplane 446 may comprise a portion of a structure 411 comprising a ship, an airplane, a satellite, a spacecraft, a vehicle, and/or another type of structure. In step 576, a dielectric layer 448 may be disposed between and/or against the conductive antenna surface 430 and the conductive backplane 446 using a direct write process 449 and/or another type of process. The disposed dielectric layer 448 may comprise a plurality of dielectric substrates 450s1-450s15 having differing dielectric constants 452c1-452c15. The disposed dielectric substrates 450s1 and 450s15 with higher dielectric constants 452c1 and 452c15 may provide higher electrical distances 440a and 440b between an adjacent portion of the provided conductive antenna surface 430 and an adjacent portion of the adjoining provided conductive backplane 446, while the disposed dielectric substrate 450s8 with the lowest dielectric constant 452c8 may provide a lower electrical distance 440c between an adjacent portion of the provided conductive antenna surface 430 and an adjacent portion of the provided conductive backplane 446.

One or more of the provided conductive antenna surface 430, the provided conductive backplane 446, and the displosed dielectric layer 448 may be flat and planar. In other embodiments, one or more of the provided conductive antenna surface 430, the provided conductive backplane 446, and the displosed dielectric layer 448 may be non-planar and/or in varying shapes. The resulting manufactured broadband antenna 428 may be planar, may have a small distance 441 between the provided conductive antenna surface 430 and the provided conductive backplane 446, may have a bandwidth greater than an octave, and/or may not have a cavity backing. In another embodiment, the resulting manufactured broadband antenna 428 may comprise: a spiral antenna 428; the disposed dielectric layer 448 may comprise concentric rings of varying dielectric substrates 450s1-450s15; and a middle portion 448c of the disposed dielectric layer 448 may comprise at least one dielectric substrate 450s8 with a lower dielectric constant 452c8 than dielectric constants 452c1 and 452c15 of dielectric substrates 450s1 and 450s15 at outer portions 448a and 448b of the disposed dielectric layer 448. In additional embodiments, the resulting manufactured broadband antenna 428 may comprise different shapes, configurations, sizes, and/or may have varying bandwidths.

In step 578, the provided conductive antenna surface 430 may radiate signals 447 such as radio frequency signals and/or other types of signals. In step 580, the provided conductive backplane 446 may reflect the radiated signals 447. In step 582, the manufactured broadband antenna 428 may perform a plurality of functions F over a broad frequency spectrum F1. In step 584, the manufactured broadband antenna 428 may provide a voltage standing wave ratio which is less than two at high frequencies. In other embodiments, the manufactured broadband antenna 428 may provide varying voltage standing wave ratios at varying frequencies. The manufactured broadband antenna 428 may have a reduced size, a reduced return loss, and/or a lower voltage standing wave ratio than antennas having similar functions at similar frequencies that do not have a plurality of dielectric substrates having differing dielectric constants.

FIG. 8 is a flowchart of another embodiment of a method 686 of manufacturing a broadband antenna 428. In step 687, a lowest required operating frequency of the antenna 428 may be determined. In step 688, a highest required operating frequency of the antenna 428 may be determined. In step 689, a uniform thickness for the entire dielectric layer 122 at a specified electrical distance may be calculated at the lowest required operating frequency based on the dielectric material having the highest dielectric constant to be used in the dielectric layer 122. The uniform thickness for the entire dielectric layer 122 may comprise the actual physical distance (not electrical distance) a conducting backplane 114 and an antenna 112 will be uniformly spaced apart from one another. In one embodiment, the specified electrical distance may comprise a quarter of a wavelength. In other embodiments, the specified electrical distance may vary. In step 690, the lowest required dielectric constant of the dielectric layer 122 may be calculated based on the calculated uniform thickness of the dielectric layer 122 at the specified electrical distance, as determined in step 689, to generate the specified electrical distance at the highest required operating frequency, as determined in step 688.

In step 691, the number of different dielectric materials to be used in the dielectric layer 122, having differing dielectric constants between the lowest required dielectric constant of step 690 and the highest dielectric constant of step 689, may be calculated based on the total bandwidth of the antenna 428. Fifteen different dielectric materials per octave in the dielectric layer 122 may provide sufficient performance. A smooth gradient is possible. In other embodiments, differing numbers of dielectric materials may be used in the dielectric layer 122. In step 692, the widths of each of the respective different dielectric materials to be used in the dielectric layer 122, as determined in step 691, may be calculated. The widths may comprise the respective distances along each dielectric material which will be disposed directly against a conducting backplane and antenna. These calculations may be done using simulation software or other systems or methods. The widths may be chosen to closely emulate the slope of a physically tapered backplane. In step 693, the dielectric layer 122 may be fabricated using the calculations and determinations made in steps 687-692. In step 694, the dielectric layer 122 may be disposed against a conducting backplane 114. This may be done using a direct-write process, or other type of process. In step 695, an antenna 112 may be disposed against the dielectric layer 122. In other embodiments, one or more of the steps of the method 686 may be varied, deleted, and/or one or more other additional steps may be utilized.

It should be understood, of course, that the foregoing relates to exemplary embodiments of the disclosure and that modifications may be made without departing from the spirit and scope of the disclosure as set forth in the following claims.

We claim:

1. A broadband antenna comprising:
a conductive antenna surface for radiating signals;
a conductive backplane; and
a dielectric layer disposed between the conductive antenna surface and the conductive backplane, wherein the dielectric layer comprises a plurality of dielectric substrates having differing dielectric constants.

2. The broadband antenna of claim 1 wherein the broadband antenna comprises at least one of a spiral antenna, an Archimedean spiral antenna, and a log periodic bowtie antenna.

3. The broadband antenna of claim 1 wherein at least one of the conductive antenna surface, the conductive backplane, and the dielectric layer are flat.

4. The broadband antenna of claim 1 wherein at least one of the conductive antenna surface, the conductive backplane, and the dielectric layer are non-planar.

5. The broadband antenna of claim 1 wherein the broadband antenna is at least one of planar, has a distance between the conductive antenna surface and the conductive backplane, has a bandwidth greater than an octave, and does not have a cavity backing.

6. The broadband antenna of claim 1 wherein at least one of the broadband antenna performs a plurality of functions over a broad frequency spectrum, and the dielectric layer was deposited against at least one of the conductive antenna surface and the conductive backplane using direct write.

7. The broadband antenna of claim 1 wherein the dielectric substrates with higher dielectric constants provide a higher electrical distance between an adjacent portion of the conductive antenna surface and an adjacent portion of the adjoining conductive backplane, and the dielectric substrates with lower dielectric constants provide a lower electrical distance between an adjacent portion of the conductive antenna surface and an adjacent portion of the conductive backplane.

8. The broadband antenna of claim 7 wherein the broadband antenna is a spiral antenna, the dielectric layer comprises concentric rings of varying dielectric substrates in between the conductive antenna surface and the conductive backplane, and a middle portion of the dielectric layer comprises at least one dielectric substrate with a lower dielectric constant than a dielectric constant of at least one dielectric substrate at an outer portion of the dielectric layer.

9. The broadband antenna of claim 1 wherein at least one of the conductive backplane comprises at least one of a surface of a ship, a surface of an airplane, a surface of a satellite, a surface of a spacecraft, and a surface of a vehicle, and the broadband antenna has a voltage standing wave ratio which is less than two at high frequencies.

10. A method of manufacturing a broadband antenna comprising:
providing a conductive antenna surface;
providing a conductive backplane; and
disposing a dielectric layer, comprising a plurality of dielectric substrates having differing dielectric constants, between the conductive antenna surface and the conductive backplane.

11. The method of claim 10 wherein the method is used to manufacture a broadband antenna comprising at least one of a spiral antenna, an Archimedean spiral antenna, and a log periodic bowtie antenna.

12. The method of claim 10 wherein at least one of the provided conductive antenna surface, the provided conductive backplane, and the disposed dielectric layer are flat.

13. The method of claim 10 wherein at least one of the provided conductive antenna surface, the provided conductive backplane, and the disposed dielectric layer are non-planar.

14. The method of claim 10 wherein the manufactured broadband antenna is at least one of planar, has a distance between the provided conductive antenna surface and the provided conductive backplane, has a bandwidth greater than an octave, and does not have a cavity backing.

15. The method of claim 10 at least one of further comprising the step of the manufactured broadband antenna performing a plurality of functions over a broad frequency spectrum, and the disposing step further comprising depositing the dielectric layer against at least one of the provided conductive antenna surface and the provided conductive backplane using direct write.

16. The method of claim 10 wherein the disposed dielectric substrates with higher dielectric constants provide a higher electrical distance between an adjacent portion of the provided conductive antenna surface and an adjacent portion of the adjoining provided conductive backplane, and the disposed dielectric substrates with lower dielectric constants provide a lower electrical distance between an adjacent portion of the provided conductive antenna surface and an adjacent portion of the provided conductive backplane.

17. The method of claim 10 wherein the manufactured broadband antenna is a spiral antenna, the disposed dielectric layer comprises concentric rings of varying dielectric substrates in between the provided conductive antenna surface and the provided conductive backplane, and a middle portion of the disposed dielectric layer comprises at least one dielectric substrate with a lower dielectric constant than a dielectric constant of at least one dielectric substrate at an outer portion of the disposed dielectric layer.

18. The method of claim 10 wherein at least one of the provided conductive backplane comprises at least one of a surface of a ship, a surface of an airplane, a surface of a satellite, a surface of a spacecraft, and a surface of a vehicle, and further comprising the step of the manufactured broadband antenna providing a voltage standing wave ratio which is less than two at high frequencies.

19. The method of claim 10 further comprising the steps of the provided conductive antenna surface radiating signals, and the provided conductive backplane reflecting the radiated signals.

20. A method of manufacturing a broadband antenna comprising:
determining a lowest required operating frequency of the broadband antenna;
determining a highest required operating frequency of the broadband antenna;
calculating a uniform thickness for an entire dielectric layer at a specified electrical distance at the lowest required operating frequency based on a dielectric material to be used in the dielectric layer having a highest dielectric constant;
calculating the lowest required dielectric constant of the dielectric layer based on the calculated uniform thickness of the dielectric layer at the specified electrical distance to generate the specified electrical distance at the highest required operating frequency;
calculating the number of different dielectric materials to be used in the dielectric layer having differing dielectric constants between the lowest required dielectric constant and the highest dielectric constant based on a total bandwidth of the broadband antenna;
calculating widths of each of the respective differing dielectric materials to be used in the dielectric layer;
fabricating the dielectric layer using the calculations and determinations made in all steps of the method;
disposing the dielectric layer against a conducting backplane; and
disposing an antenna against the dielectric layer.

21. The method of claim 20 wherein the uniform thickness comprises the physical distance the conducting backplane and the antenna will be uniformly spaced apart from one another.

22. The method of claim 20 wherein the specified electrical distance comprises a quarter of a wavelength.

23. The method of claim 20 wherein fifteen different dielectric materials are used per octave in the dielectric layer.

24. The method of claim 20 wherein at least one of the widths comprise respective distances along each dielectric material which will be disposed directly against the conducting backplane and the antenna, the width calculations are done using simulation software, and the widths are chosen to emulate a slope of a physically tapered backplane.

25. The method of claim 20 wherein the dielectric layer is disposed against the conducting backplane using direct-write.
